(19) United States
(12) Patent Application Publication
(10) Pub. No.: US 2013/0089849 A1
(43) Pub. Date: Apr. 11, 2013

(54) WIRELESS INTERNET CLASSROOM ENVIRONMENT (WICE)

(71) Applicant: Alexander Nixon Huang, San Ramon, CA (US)

(72) Inventor: Alexander Nixon Huang, San Ramon, CA (US)

(21) Appl. No.: 13/543,777

(22) Filed: Jul. 6, 2012

Related U.S. Application Data
(60) Provisional application No. 61/505,124, filed on Jul. 7, 2011.

(51) Int. Cl. G09B 19/00

(52) U.S. Cl. CPC G09B 19/00
USPC 434/352

(57) ABSTRACT

The Wireless Internet Classroom Environment (WICE) is a system comprising a Personal Computer and a number of tablet computers, plus the software programs that form tools that allow schools to fully digitalize their classrooms. This system can create a completely electronic and paperless learning environment which still incorporates the experience of face to face learning and hands-on activities. There are two software functions to the WICE. The teacher would install the “server” software on the Teacher-PC which has internet access and WiFi tethering capabilities. The students would install the “client” software on their Personal Digital Assistant (Student-PDA) devices, or tablet computers which have WiFi terminal capabilities. The Teacher-PC and Student-PDAs together form a wireless classroom learning environment where the teacher can deliver the class materials electronically while maintaining control and engagement of all students.

### CLAIM OF PRIORITY

This Application claims priority under 35 U.S.C. §119(e) from earlier filed U.S. Provisional Application Ser. No. 61/505,124, filed Jul. 7, 2011, the entirety of which is incorporated herein by reference.

### BACKGROUND

1. Background

Today in the classroom, the teaching is conducted generally by using paper. The teacher will hand out class materials to students. The student will have both text books and class materials (in paper) to read. In addition, the teacher will use examination papers for test taking and students will take notes in their paper notebooks.

Generally, students are not allowed to use computers and handsets in the classroom for the fear that they might use it for other purposes such as playing games and cruising the internet. In many middle schools and high schools, although most students have access to computing devices, most of them are not allowed to use them during classes.

Students are encouraged to use their computers and tablets after class. In this case, the students generally use them at home and off campus in order to type up essays and complete digitally assigned homework that is to be printed out later into hard copy. This is not very GREEN or environmentally friendly.

Even in cases in which schools have a One-to-one program, meaning students are allowed to use their laptops in classes, paper documents are still predominantly used for learning, homework, and testing. There remains the issue of managing students during class, and preventing them from using their devices for accessing extraneous or inappropriate material during class.

The key of the invention is that it creates What one often finds in one-to-one learning environments in the current educational system is that the freedom gained by the students through using their PDA's interferes with the teacher's ability to keep students on task. This invention empowers teachers who require more control over their class. Once again, the unique teaching style of every teacher is preserved as each teacher will be able to select preferences on how they want to run their class.

In order for this invention to behave as intended, a new file type called a WICE file will be introduced and will allow tablet stylus editing to occur on top of the original work document(whether word or pdf.) Features of the software will allow for these pre existing word documents to be converted if needed. The basic system functionality is as follows:
Features for the WICE client software and WICE server software will be discussed in more detail further down.

### SUMMARY

I have invented a system/software apparatus that will allow classrooms with a one-to-one program to function without paper. My invention allows teachers to have full oversight over the digital activities of their students while they are in the classroom using personal computing devices. This invention is unique because it targets individual classrooms within a whole school system, allowing each teacher to tailor the apparatus to fit his/her preferences to meet his/her class' specific needs. It also allows schools to be flexible because though each classroom is running the same software, each classroom is also run by a different teacher who can personalize the software's impact on the students through his/her own classroom preferences. This in turn also allows more comfort for teachers as they switch to WICE.

WICE digitalize a classroom and all its functions. From assessments to homework, The WICE will digitalize all the paper required for classroom tasks and the process of distributing paper as well as collecting it. Physical paper will no longer be necessary for the classroom to function, thus creating ecologically friendly classrooms and schools.

### BRIEF DESCRIPTION OF THE DRAWINGS

FIG. 1 depicts a diagram of a controlled teaching environment within the school's facilities that allows both teachers and students to carry out their courses without using paper.

FIG. 2 depicts a menu format of all the below features as well as the interaction between some CLIENT/student functions and SERVER/teacher functions.

FIG. 3 depicts a menu format of all the below features as well as the interaction between some SERVER/teacher functions and CLIENT/student functions.

### DETAILED DESCRIPTION

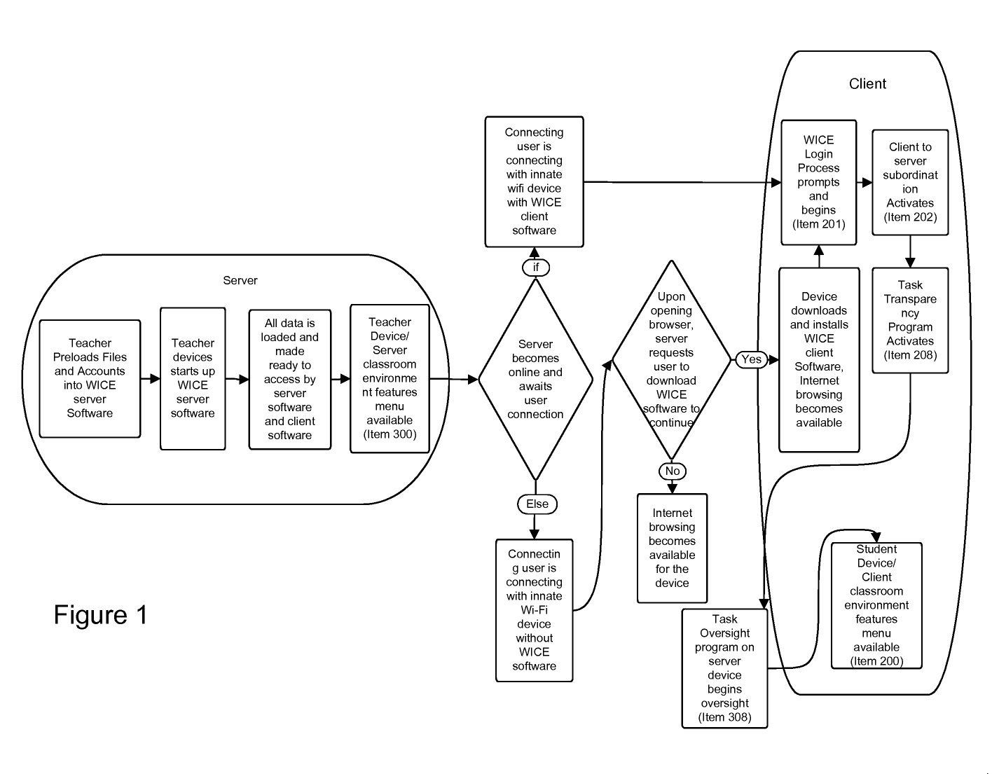

FIG. 1 depicts software that is split up into two subsystems. One subsystem is the CLIENT software which is used by the students and the other is the SERVER software which is used by the teachers.

The CLIENT/Student software will consist of these features:
1) Network Login/Logout
2) Client to Server Subordination
3) Digital Folder System
4) File Collection/Receiving Program
5) Digital Notebooks/Homework/Textbooks
6) Digital Testing Program
7) Grade Check System
8) Task Transparency and Limited Internet Access
9) Document Conversion Tool

The SERVER/Teacher software will consist of these features:
1) Charting and Attendance
2) Open Digital Folder System
3) Call Function Download/Upload and Server Authority
4) Document Conversion Tool
5) Digital Homework/Textbook Collection and Distribution Program
6) Digital Test Giving Program
7) Digital Grade Book
8) Task Transparency Oversight and Controllers Internet Access

The SERVER software (FIG. 1) essentially turns the teacher device into a server for student devices. The teacher device will be able to share its internet with all of the students connected to it by acting as a Wi-Fi access point. The student devices will be able to login to the teacher's service and that is when they will be prompted to run their WICE software. If their device does not have the WICE software, they will be prompted to download it. Upon download and installation, the student copy of WICE will run a task manager that tracks each of the processes of the student device. This information is also relayed to the teacher server, from where the teacher can check on students and record attendance. The teacher's server also has the capability to manage a customizable firewall which will restrict student's access to internet.

The WICE program on the student device will be serving as a digital notebook, folder, planner, testing medium, homework distribution and collection medium and digital textbook. Students will be able to personalize their WICE folders and programs. Student devices will also be able to check the teacher's grade books depending on whether or not the teacher has enabled student viewing. The main feature of this software for tablets is that it will allow file editing through tablet drawings, much like a smaller version of today's SMARTBOARD technology. While this software is more versatile for touch screen devices it is still compatible with computers and PDA devices without touch screen features. Mouse movement can also edit WICE files much like a pen or touch screen for a tablet. Text box insertions will also be provided as a feature to edit WICE files.

The WICE program on the teacher device will act as the host/server. The teacher device/server will record the activities of each student using the information collected from the task manager programs in the student software. Teachers may set a list of class appropriate programs and class illegal programs. Any unauthorized active programs will immediately alert the teacher device as to which student is not following class guidelines and allow for the teacher to respond (FIG. 1, item 308). The teacher's device will be able to prompt student devices with a message, force student devices to run certain programs, download certain files from the server and ask them to upload files to the server as well. This key feature allows teachers to exert their own teaching style by giving them to power to personalizing their WICE program and managing student devices in their class. If students do not undergo the action that the teacher device requests them to do, teachers will be alerted.

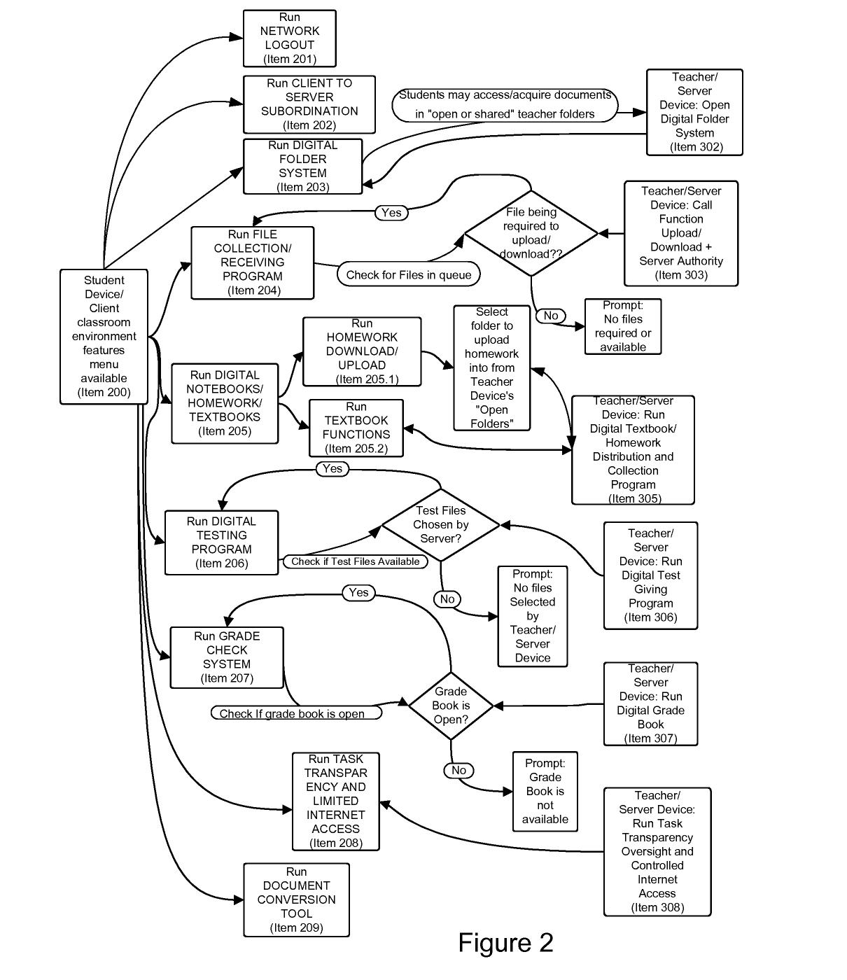

Software for Students Features—CLIENT FUNCTIONS/FEATURES. FIG. 2, 201 depicts a Network login/logout—upon starting the program, students will be able to choose a wi-fi network emitted by a teacher device and login into it. After logging in, a menu will display showing all the possible features of the device (1-9) that the student may run at his/her discretion.

If students do not have the program and software preloaded on their device and they connect to the teacher's Wi-Fi using their devices innate Wi-Fi capability, the teacher device will send a copy of the program/software to the student's device.

FIG. 2, Item 202 depicts a Software for Students Features—CLIENT FUNCTIONS/FEATURES—Client to Server Subordination—This is an innate feature within the program once the client to server connection is created. It will allow the server(teacher device) to prompt the client(student device) to run different programs, display a custom notice by the teacher(possibly class instructions for today's class), download a file, enter testing mode(discussed further in the document), etc.

FIG. 2, Item 203 depicts Software for Students Features—CLIENT FUNCTIONS/FEATURES—Digital Folder System—This program will encompass the DIGITAL NOTEBOOK, DIGITAL TEXTBOOK, and DIGITAL HOMEWORK TURN-IN/WORK programs. It serves to organize the text/PDF documents that are all involved in the above programs; this program will allow students to create their own folders and move documents saved onto their device into specified folders.

FIG. 2, Item 204 depicts a Software for Students Features—CLIENT FUNCTIONS/FEATURES—File Collection/Receiving Program—Students will be able to browse through “open” folders that teacher servers display and acquire documents for class (refer to (Section 5.2, 5.3) in teacher functions below). Student devices will also have a program that will be susceptible to being called on by teacher devices to upload documents or download documents for class (used in test taking, homework collect, and etc. mentioned further below).

FIG. 2, Item 205 depicts a Software for Students Features—CLIENT FUNCTIONS/FEATURES—Digital Notebooks—Digital Notebook is a built in programs within the software that allows students to partition their memory into different amounts of pages (Notebook memory) into different courses. The program also functions like a digital notebook, textbook and homework folder for the student. The teacher can directly push documents or retrieve documents from the corresponding folders of the students' tablet devices Each digital notebook page is a document that can be written on by a tablet, or typed on. It will also support handwriting and direct drawing on the page. This program will have the Optical Character Recognition (OCR) capability to convert the handwriting into font characters.

FIG. 2, Item 205.1 depicts a Software for Students Features—CLIENT FUNCTIONS/FEATURES—Homework—This program will also serve to automatically download homework files from the teacher's server software into a desired location on the student's client device memory.

The Digital Notebook of the client software will contain folders for different classes' homework. Each student's client software will automatically remember where to save homework depending on which teacher's server the device is currently logged onto. Homework is done in this program because homework files will be preset/locked notebook pages that students download from teacher devices and can edit. This program also allows students to choose documents and send it to the teacher's server software, provided that the teacher's device is set to receive these files.

FIG. 2, Item 205.2 depicts Software for Students Features—CLIENT FUNCTIONS/FEATURES—Textbooks—Textbooks are simply giant documents in folders within this program and can be opened through the notebook. The teacher server device can distribute textbooks through uploading to student devices. Only teacher devices can send textbook files and recall them from student devices. Students must accept materials sent by the teacher device to their device and store it into their desired folder, once there, the textbook file becomes read-only, un-copy-able. However, textbook files CAN be moved, if and only if they are moved into a teacher/server folder. Teachers can collect textbook files at the end of the year by calling all client devices to remove them (A feature in the server software).

FIG. 2, Item 206 depicts Software for Students Features—CLIENT FUNCTIONS/FEATURES—Digital Testing Program—Upon using this part of the software, students will have a separate window opened up and locked to their screen. Students will enter a test entry code given to them by teachers which will load the test document onto their screen as the student device prepares to download the test file. The teacher device will upload this document to the student once the code is entered. This lock is only un-lockable by a teacher's test-end code, which will be different for different tests. Exclusively for tests that are WICE files, students will be able to edit on top of the original document in order to finish and complete the test. When the test taking is finished, a done button with confirmation can be pressed and it will send the finished test as an editable/stylus editable PDF to the teacher's device.

FIG. 2, Item 207 depicts a Software for Students Features—CLIENT FUNCTIONS/FEATURES—Grade Check System—Teachers can open up their grade books digitally at will and students will be able to view their individual grades for projects by using a function within the program which will open up their own personal column in the teacher's grade book. Students, upon running this program, will attempt to connect to the teacher server's grade book to see their own grades. If the teacher's grade book is in viewing/sharing mode, connection will succeed. Student devices and teacher devices will be able to access their respective grade book functions from the main menu of the software.

FIG. 2, Item 208 depicts a Software for Students Features—CLIENT FUNCTIONS/FEATURES—Task Transparency and Limited Internet access—Upon logging into the teacher's classroom server using the WICE software, student machines will relay all of their active tasks (similar to task manager) to the teacher's device. The teacher's device will have a white list +black list of tasks and if one of a student's active tasks are on the black list, the teacher's device will notify the teacher.
Internet Access
Student devices will have internet access that is controlled by the teacher's
WICE server's settings which would allow online research to be conducted during the class when enabled.

FIG. 2, Item 209 depicts a Software for Students Features—CLIENT FUNCTIONS/FEATURES—Document Conversion—Student devices running WICE software can select different documents saved onto their device and the teacher device and convert them into WICE compatible documents through use of the WICE software. They may also use this to convert WICE documents into other file types.

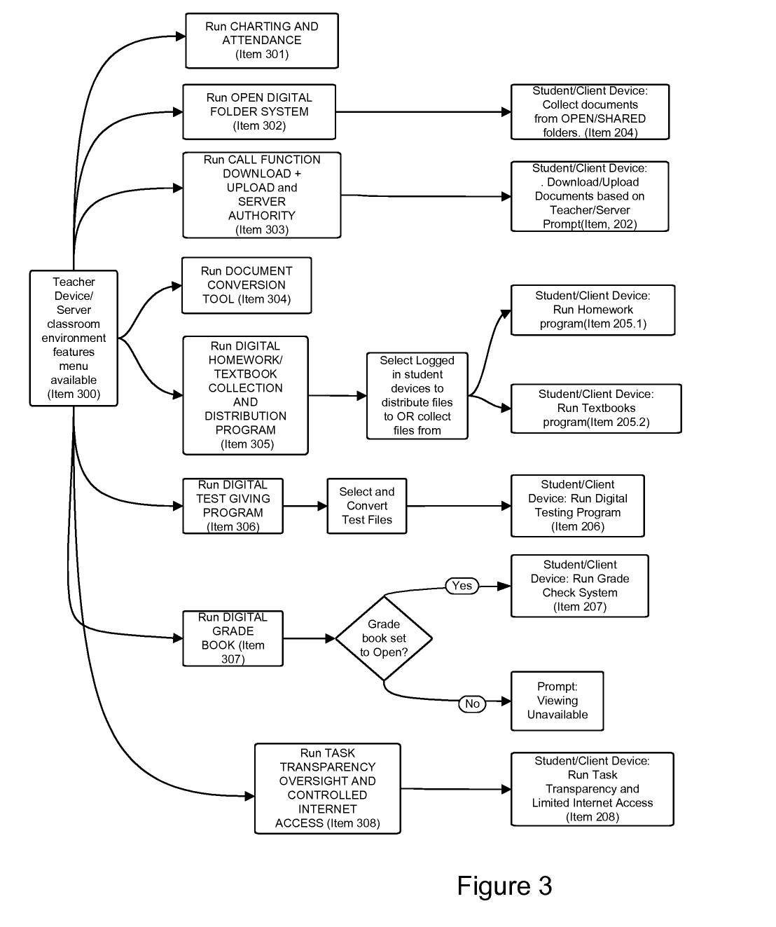

FIG. 3, item 301 depicts SOFTWARE FOR TEACHERS FEATURES—SERVER FUNCTIONS—Charting and Attendance—When the teacher machine runs the WICE software, a classroom server is set up. This server will act as a Wi-Fi server for student devices running the matching client/student version of the WICE software. Machines without the software however can connect to this Wi-Fi AP via innate Wi-Fi capabilities and will be asked to download a copy of the WICE client software from the teacher device upon doing so. Teachers create accounts for their students using the WICE server software. The software will automatically record student accounts logging into the classroom server and logging out. The WICE software will also notify the teacher of missing/absent students and record late log-ins. The teacher device will also record any student misconduct by recording the amount of times a device has ran an unauthorized program during class time.

FIG. 3, item 301 depicts SOFTWARE FOR TEACHERS FEATURES—SERVER FUNCTIONS—Open Digital Folder System—Much like the student version, WICE server software will allow teachers to create their own folders and organize things as they please. One feature to their folders however, is the ability for teachers to make them “shared” to students. Meaning, through the WICE interface, students will be able to access “Shared” folders on the teacher's server and obtain class materials from those folders. Teachers have the ability to customize their folders' sharing capability.

FIG. 3, item 302 depicts SOFTWARE FOR TEACHERS FEATURES—SERVER FUNCTIONS—Call Function Download+Upload/Server Authority—Teacher devices running the WICE server software will be able to call all student/client devices connected to its server to download documents (file selected by teacher) or upload documents (to a folder that the teacher selects). They can either prompt students to download, or force a download which will immediately start the download of the file on the student device and notify the student device as to when and what was downloaded when the download is complete.

FIG. 3, item 304 depicts SOFTWARE FOR TEACHERS FEATURES—SERVER FUNCTIONS—Document Conversion—Teacher devices running WICE software can select different documents saved onto the teacher device and convert them into WICE compatible documents through use of the WICE software. They may also use this to convert WICE documents into other file types.

FIG. 3, item 305 depicts SOFTWARE FOR TEACHERS FEATURES—SERVER FUNCTIONS—Digital Homework/Textbook collection and distribution program—Through use of the Document Conversion and Call Function Download+Upload features, teacher devices running WICE software will be able to create homework documents, organize them into folders and display a pop up on student devices to download files and upload them.
Specifically for homework (FIG. 3, Item 305.1), teacher devices will designate “Shared” folders in which students can collect new homework and also designate folders in which students must upload completed homework. Teachers have full control in collecting homework because they can prompt each student machine to upload it using the upload call feature.
Specifically for textbooks (FIG. 3, Item 305.2), teacher devices will be able to upload textbook documents into folders selected by the student in the WICE software. Teachers can also force collect these files at the end of the year using the call function upload program. As stated before, textbook documents are located within unique, un-copyable, and only moveable by WICE teacher software devices folders. Only teachers have the power to move textbook folders.

FIG. 3, item 306 depicts SOFTWARE FOR TEACHERS FEATURES—SERVER FUNCTIONS—Digital Test giving program—Upon using this program in the teacher version of WICE, the teachers interface will ask the teacher to choose a file to convert into a “WICE test” document. This will make that document's current features preset and unchangeable, but will allow add-on editing. The teacher can then run the testing program using this document as the test paper. As the teacher WICE server runs this testing program, student devices will be prompted to run their own test program. Students will be required to enter a test code provided by the teacher to download and receive the test paper. There will be a check list that waits for all student devices logged into the classroom network before testing procedures continue further. After the system sees that all student devices are running the testing program or if the teacher initiates testing procedure manually, students will then be required to enter a test code provided by the teacher to download and receive the test paper. Upon completion of the test, the teacher can force the student devices to upload their test papers, whether they are finished or not in the allotted time. The teacher then provides students with a test exit code that the students enter to exit testing procedures on their device.

FIG. 3, item 307 depicts SOFTWARE FOR TEACHERS FEATURES—SERVER FUNCTIONS—Digital Grade Book—As teachers receive work from students they will be able to grade it and organize it into folders for specific students and enter their grades into their grade book. The WICE software for teachers will connect student accounts to their personal grade books and teachers may enable viewing of the grade book, allowing students to access their own individual grades as long as viewing mode is activated by the teacher. Student devices and teacher devices will be able to access their respective grade book functions from the main menu of the software. The grade book program itself will be in the form of a traditional table spreadsheet with assignment names and grade average calculations much like the ones found in programs such as Power School.

FIG. 3, item 308 depicts SOFTWARE FOR TEACHERS FEATURES—SERVER FUNCTIONS—Task Transparency Oversight and Controlled Internet Access When students are logged into the teacher's WICE server, the WICE software from the teacher and student will begin to interact. The student software will make all of the student's devices active programs visible to the teacher's WICE software through a check list interface that will display each student device's active programs and/or display devices that are running illegal programs. The teacher can then white and black list certain programs and can punish students for having black listed programs open as the WICE software will alert the teacher to a breach. The WICE software will record breaches of the black list/white list by different student devices in a network history that will be individually attributed to each student device that is registered on the classroom network.

The WICE software will also be able to control the usage of internet by students as it sets up a firewall that blocks sites that the teacher can choose at his/her discretion. As long as the student devices are connected through the WICE software to the teacher's WICE server they are bound by this firewall. Teachers can edit the sites blocked by this firewall at will.

Global features/special notes: WICE files and document compatibility In the above features, WICE files are mentioned as a new file type that other existing documents can be converted into for the WICE program to use and allow certain aspects of features to work(see section 4.6 and 5.6 for an example.) However, in the modern educational scene, not all student's might be able to use a WICE file to its fullest extent as its purpose is to allow tablet editing on top of existing word/PDF files etc. Thus, in the below features, teachers may not always need to convert files into WICE files in order to carry out the above protocols. In order to accommodate situations where a teacher may have both students that do require WICE files and students that do not, a simple double prompt of downloading the required files(one converted and the other not) will suffice to address everyone's needs.

1. A method of coordinating teaching functions comprising:
providing a server computer;
providing a server-controlled software interface; and
providing a client computer coupled with said server computer configured to run said server-controlled software interface;
wherein said software interface is configured to allow a server computer to communicate with and at least partially control said client computer;
wherein said server server computer is configured to send instructions to a user of said client computer; and
wherein, if a user of said client computer fails to comply with aid instructions within a prescribed period of time, said server computer is notified.

2. The method of claim 1 wherein said client computer is a tablet computer.

3. The method of claim 1 wherein said server computer is configured to control said client computer's access to external services.

4. The method of claim 3 wherein said client computer is configured to transition between a normal operating mode and a testing mode.

5. The method of claim 4 wherein said client computer is configured to download files from said server computer and configured to upload files to said server computer.

6. The method of claim 4 wherein said client computer is configured to download a file from said server computer, allow a user to make monitored modifications to said downloaded file and upload said downloaded and modified file to said server computer.

7. The method of claim 1 wherein said client computer includes user-configurable memory.

8. The method of claim 7 wherein said client computer is a tablet computer.

9. The method of claim 8 wherein said client computer includes software configured to convert a user's handwritten input into machine-encoded text.

10. The method of claim 9, wherein functionality of said client computer is configured to be restricted based upon a receipt of a signal.

11. A system for coordinating teaching functions comprising:
a server computer;
a server-controlled software interface; and
a client computer coupled with said server computer configured to run said server-controlled software interface;
wherein said software interface is configured to allow a server computer to communicate with and at least partially control said client computer;
wherein said server server computer is configured to send instructions to a user of said client computer; and
wherein, if a user of said client computer fails to comply with aid instructions within a prescribed period of time, said server computer is notified.

12. The system of claim 11 wherein said client computer is configured to transition between a normal operating mode and a testing mode.

13. The system of claim 12 wherein said server computer is configured to control said client computer's access to external services when said client computer is in a testing mode.

14. The method of claim 13 wherein said client computer is configured to download a file from said server computer, allow a user to make monitored modifications to said downloaded file and upload said downloaded and modified file to said server computer.

15. The method of claim 14 wherein said client computer includes user-configurable memory.

16. The method of claim 15 wherein said client computer is a tablet computer.

17. The method of claim 16 wherein said client computer includes software configured to convert a user's handwritten input into machine-encoded text.
